(19) United States
(12) Patent Application Publication
(10) Pub. No.: US 2004/0254898 A1
(43) Pub. Date: Dec. 16, 2004

(54) Vanity postage stamps and method

(76) Inventors: Peter Parker, Keller, TX (US); John J. Mampe, Fort Worth, TX (US)

Correspondence Address: PHILIP G. MEYERS LAW OFFICE, 1009 LONG PRAIRIE ROAD, SUITE 302, FLOWER MOUND, TX, 75022, US

(21) Appl. No.: 10/458,761

(22) Filed: Jun. 10, 2003

(51) Int. Cl. G06F 17/00

(52) U.S. Cl. 705/402

(57) ABSTRACT

A method of providing a customer with postage stamps including images provided by the customer includes (a) receiving image data from a customer, (2) combining the image data with postal indicia to produce an electronic image of a postage stamp, (3) providing an image of a postage stamp including the image data received from the customer for customer review, (4) reviewing the image data for compliance with predetermined criteria, (5) printing the postage stamp, and (6) forwarding the printed stamps to the customer.

### TECHNICAL FIELD

The invention relates to customized, vanity postage stamps and a method of creating the stamps.

### BACKGROUND OF THE INVENTION

Postage stamps are an indication that postage has been paid for the delivery of a mail piece. These postage stamps are typically produced and issued by a government agency and procured for use by the general public. The postage stamps can either be obtained at a local post office, procured out of a postal vending machine or via mail order from a postal distribution facility, or procured and printed using a personal computer to print an indicia based stamp. Alternatives to stamps include permit imprints wherein the permit holder is authorized to print an endorsement on envelopes submitted to a post office in bulk, and meter and bar code indicia printed via devices or computers that safeguard the revenue from the transaction. For holidays or special events the postal authority often produces a limited number of special edition or commemorative stamps which are distributed for sale and used for the payment of postage or alternatively are saved as a collector's item. Postage is also generated that splits the revenue earned to the governing agency and deposits a donation to a non-profit organization.

A number of methods have been proposed to enable vending machines to take a photo and then issue a personal postage stamp containing the image captured by the photograph with appropriate revenue controlled through the vending device. Such prior art attempts have not resulted in any marketable devices due to a number of process related limitations. A major limitation has been the lack of a review process to assure that postage stamps so issued meet the social norms of the relevant society in which the postage is printed. Additionally, security features and control of the stock upon which postage is printed have not been designed to meet the process integrity and security concerns of postal administrations.

The method and apparatus of the invention described herein is calculated to overcome the foregoing shortcomings and deficiencies. In accordance with the invention, vanity type postage may be created and issued under the control of the relevant postal administration while providing the general public with wide latitude to design customized artwork, graphics or photographic representations as desired.

### SUMMARY OF THE INVENTION

In the method of the invention, a postal customer would receive personalized postage stamps purchased through a postal agency (for example, the United States Postal Service) with artwork, graphics or pictures provided by the user. Customer provided clip art or photographs provide the means by which postage is personalized. This clip art is incorporated into an approved postage format and customer selected denomination. In accordance with the method, personalized postage can either be printed by the postal authority on preprinted stock at a central location or using a personal computer and printer with approved software. The postal agency (such as the USPS) could add a surcharge or separate fee to the postage to cover the expense and special handling involved in providing the personalized postage.

In accordance with the invention, a system for printing postage stamps on stamp stock approved by a postal agency or its authorized representative includes means for receiving customer-provided image data in electronic form, computer-implemented means for incorporating the customer-provided image data into approved customized postage, a printer that prints the combined artwork and postage on the stamp stock, thereby creating a personalized postage stamp of a desired value; and means for receiving payment from a customer. In a preferred embodiment, the means for receiving customer-provided image data comprises a computer connected to a global computer network. In this respect, the means for receiving payment from a customer may be a secure computer communications link whereby a customer may pay for the postage via the secure link.

In another aspect, the system includes means, such as a document scanner, for converting printed image data to electronic form. In order to insure that the customer provided clip art or images that are suitable for use, the system may include means for displaying the customer-provided image data for review by a postal authority responsible for determining whether the clip art or images are acceptable. Further, the system may include a customer accessible database of image data that a customer may utilize to compose an image for use on a postage stamp. To insure customer satisfaction, the system preferably provides means for transmitting an electronic image of the postage stamps to the customer for review before the stamps are printed. In another aspect, the system may also provide a database or similar means for storing clip art or images provided by the customer for future use.

In another variation, in accordance with the invention a method of providing a customer with postage stamps including images provided by the customer includes the steps of: (1) receiving image data from a customer in electronic form, (2) combining the image data with postal indicia to produce an electronic image of a postage stamp, (3) transmitting an image of a postage stamp including the image data received from the customer for customer review, (4) displaying the image data for review by a postal authority (5) printing the postage stamp, and (6) forwarding the printed stamps to the customer. In addition to the foregoing the method may include billing the customer and collecting payment for the postage, electronically or otherwise. In another variation, the customer may be provided access to a data base of pre-approved clip art or images that the customer may utilize, alone or in combination with customer provided clip art and images to produce one or more images to be used on personalized postage.

In yet another variation, a method of providing a customer with postage including customer provided images includes receiving image data from a customer and reviewing the image data for compliance with predetermined criteria. Preferably the image data is received via electronic transmission, however it is contemplated that the image data may be received as printed images or image data recorded on magnetic media. The image data is combined with postal indicia to produce an electronic image of a postage stamp. The electronic image is used to print the postage stamp, after which the stamps are forwarded to the customer. In one variation, the method includes providing means, such as a document scanner, to enable the customer to convert printed image data to electronic form. The means may be provided at a local postal office or at a self-service center such as a kiosk remote from postal offices. In this regard, it is preferable to also provide the customer with means for remote display of an electronic image of the postage stamp prior to printing the postage as well as means for electronically paying for the postage.

### BRIEF DESCRIPTION OF THE DRAWINGS

FIG. 1 is an example of a postage stamp in the portrait orientation; and

FIG. 2 is an example of the postage stamp in the landscape orientation; and

FIG. 3 is a schematic representation of a system according to the invention.

### DETAILED DESCRIPTION OF THE INVENTION

In a first variation, a postal authority such as the United States Postal Service (USPS) provides software to a customer that can be used to import digital pictures or clip art for the preparation of a postal stamp. In accordance with the invention, clip art or digital pictures imported for use on vanity type postage stamps has areas reserved for the name of the issuing agency such as “USA” or “US Postage” and an additional area reserved for the preprinted postage amount, for example, “34” or “37.” Included in the software is a proofing feature that displays to the customer a thumbnail, or small scale digital representation of the completed stamp designed by the customer. In an alternate variation of the invention, the customer simply submits artwork or photographs to the post office which in turn produces the vanity type postage stamps.

Using the software, the customer submits selected clip art to the appropriate postal administration, such as the USPS via an email address included with the software. The selected clip art is directed to a central philatelic organization such as the USPS Philatelic fulfillment office. In this variation, payment for the postage stamps may be made with a credit or debit card via a secure connection. Alternatively, the customer may be billed. The customer is advised prior to transmission that the customer is responsible for the verification of the artwork proof, and that printed output will be generally representative of the thumbnail output included with the software. Only quality problems with printed output (miss-registration, or loss of dye color) would be reimbursed by the issuing agency. It is anticipated that postal administration printing the custom stamps, the issuing agency can charge a surcharge to cover the cost of the labor, equipment, special stock and other costs associated with the printing process.

The vanity type postage stamps may be printed by the USPS Philatelic facilities, or locally by the local post office. In the case where the postage stamps are printed at the local post office, processing could be done immediately during slack periods, or the customer could return to pick up the stamps at a to be determined time. If the vanity type postage stamps are printed at a central facility, (national fulfillment) the processing fee may include an additional handling fee to cover the cost of return postage. Inherent in either a nationally based or locally based system is the ability to review the postage to assure the verbiage, artwork or graphics conform to acceptable societal standards.

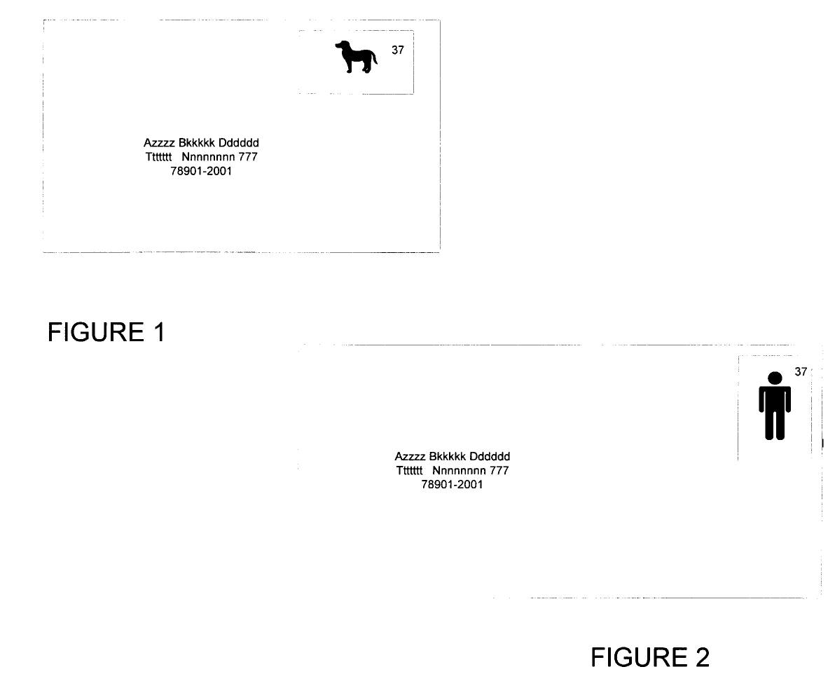

As an alternative to ordering the vanity type postage stamps via the internet from a central, national printing facility or by visiting a local post office, appropriately equipped postage kiosks may be conveniently located at shopping centers, malls and similar locations. In this variation the customer could create his or her own customized postage stamps using his or her own pictures and or artwork. The customer would have the ability to scan the pictures or art work, size and crop the artwork and/or utilize special effects. The customer would have the option of formatting the stamp in a portrait format as shown in FIG. 1 or in a landscape format as shown in FIG. 2.

Preferably, the kiosks would be equipped to accept payment in the form of cash, as well as credit and debit cards. The completed artwork would be transmitted electronically from the kiosk to a regional or national processing center such as the USPS Philatelic facilities where postal employees can review and proof the item prior to printing & delivery to the customer.

In yet another variation, the customer would present the pictures or artwork on magnetic media or via electronic means with appropriate payment to their local post office. At the post office local review of the product and printing would occur. The customer would then receive the product without the delay inherent with mailing from a central printing location.

In yet another variation, the software includes or enables a postal customer to access a library of preapproved clip art and pictures. In this embodiment, the customer accesses a fully automated stamp design web site where the customer may cut and paste from a large library of canned, preapproved images to design a custom stamp. In this fashion, human review of the artwork or pictures is eliminated while the customer is still permitted some originality in design by allowing multiple canned images to be used, overlaid or combined in a single stamp. A further refinement of this variation includes means for allowing a customer to submit artwork for addition to the postal stamp image library. In this scenario, the system may provide for customer access to the library of artwork on a fee basis with or without a password.

In order to prevent fraud, the customized postage stamps would be printed on secure paper that contains features to assure that the postage is legal for the intended purpose. The paper stock could include special fibers, metallic strips or other secure features to protect against fraudulent copies. The secure paper may contain phosphorescent areas or other secure markings positioned behind the official area such as the “USA” display, the area displaying the revenue amount and/or on the margins of the stamp. The paper stock may either be preprinted with an amount field such as the displayed “USA,” the amount of revenue, or the fields could be left blank. In either case, the paper would be considered a controlled stock item. The use of secure paper will assure that the stamps can be detected as valid postage by automated scanning and canceling equipment and/or easily verified by postal carriers and other personnel who would review mail for validity purposes.

In the case of preprinted postage sheets, the software requires that the revenue amount information be entered either by the customer in the provided software or by the postal clerk prior to printing the stamp order. This ensures that the proper sheet of preprinted stamps for the desired number and amount of postage is utilized. In the case where the revenue is not printed on the stock sheet, the amount would be enter by postal employees prior to printing the stamps. This amount would then be printed on each stamp at the time of printing.

Flexibility in design permits stamps to be printed in both landscape and portrait orientations with preprinted stock sheets supplied in both orientations. One option is to print the amount of the stamp and such official words as “USA” or “US Postage” in which case the stock and software template could be designed for either orientation.

Software in the local printing process will contain revenue features that calculate the amount of the printed stamps, by sheet of stamps and quantity of sheets, plus any surcharge amount. This data will be uploaded under a handshake protocol to the local point of sale terminal or other postal computer accumulating revenue to assure that the transaction is properly recorded.

A printer with dyes appropriate for printing on the secure stock and selected for long life with minimal damage from water droplets will be used to print the stamps. A large scale version of this concept could also be designed to print on coil stock paper. This will require a specialized printing process and is likely to only be made available through national distribution, such as, the USPS Philatelic office, or other United States Postal Service authorized postage providers. The system will also contain the provision to generate a proof prior to printing on the stamp stock. This could include printing of the replicate of the designed stamp on a plain sheet of paper with an option of a diagonal stripe signifying that the facsimile is a proof as opposed to a valid postage stamp.

Another potential advantage of the invention is that it provides a means for a postal administration to print new denomination stamps after a rate change using the blank stamp stock. Frequently the rates change and the Postal Service does not have the necessary lead-time to print denominated stamps of the proper value. To alleviate this problem, the USPS has printed alphabetized stamps that have whatever value the USPS assigns to them at the time of a rate change. However, such alphabetized stamps are normally not acceptable for international mail and tend to cause confusion within the public. The ability to print on demand properly denominated stamps would eliminate the need to print and stock the alphabetized versions. Official USPS artwork could be used for these transitional stamps. A further refinement of this method would provide the postal administration the capability to download official artwork to local post offices at any time through a network connection.

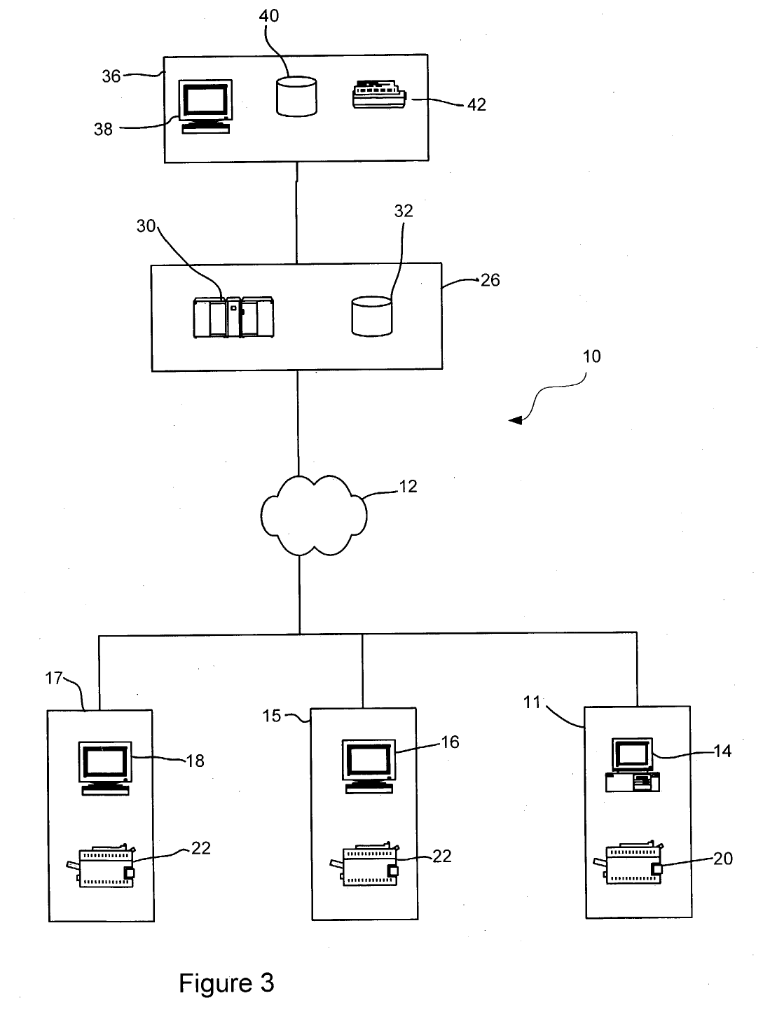

Turning to FIG. 3, in one aspect a system 10 according to the invention utilizes a computer network 12 that communicates with one or more of a postal customer's personal computer 14 located in the customer's home or office 11, a computer 16 located at a local postal office 15 and/or a computer located in a kiosk 17 or similar commercial location, for example a private mailing center or mall. In each case computers 14, 16 and 18 are provided or connected to printers 20, 22 and 24 for printing postage and/or proofs for review by customers.

A central processing/billing facility 26, equipped with one or more computers 30 and data bases 32 communicates with computers 14, 16, and/or 18 to receive requests for customized postage, including clip art or scanned images as described above. Data base 30 is provided to maintain a record of requests and images for billing purposes and for retrieval in case the customer wishes to place a repeat order. In the illustrated embodiment, customer requests including customer supplied images and/or clip art are forwarded to a central review/approval center 36. Preferably, the images are forwarded electronically via network 12. Alternatively, the requests and images may be stored on electronic media that is physically transferred from central processing/billing facility 26 to review/approval center 36. Center 36 is equipped with one or more computers 38 and databases 40 to receive clip art and images forwarded by customers, display the images and art for review and format the images for printing as postage. In one variation, databases 40 include catalogs of pre-approved clip art and/or similar images that may be selected and used by a customer in the design of personalized postage.

Upon submission to center 36, the customer supplied images and/or clip art are reviewed for compliance with applicable postal rules, regulations and guidelines. Although it is contemplated that the customer will format the postage including the images and/or clip art, this function may also be accomplished at central review/approval center 36. The review/approval center 36 is also equipped with one or more printers 42 for printing the requested postage upon approval, after which the postage is mailed to the customer or to a local postal office 15 for pick up. Alternatively, upon approval, the formatted postage including the customer supplied images and art may be transmitted back to the central billing/processing facility 26, local postal office 15 or kiosk 17 for printing. Further, in some cases, it may be possible to send the approved and formatted postage to the customer's home or office 11 for printing.

It will also be appreciated that the functions of central billing/processing facility 26 and review/approval center 36 may be consolidated in a single facility. Thus, system 10 contemplates providing the postal customer the option of requesting and receiving customized postage with customer-supplied images through a variety of different and convenient channels.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is, therefore, intended that the appended claims encompass any such modifications or embodiments.

1. A system for printing postage stamps on stamp stock approved by a postal agency or its authorized representative, comprising:
means for receiving customer-provided image data in electronic form;
computer-implemented means for incorporating the customer-provided image data into approved customized postage;
a printer that prints the combined artwork and postage on the stamp stock, thereby creating a personalized postage stamp of a desired value; and
means for receiving payment from a customer.

2. The system of claim 1 wherein means for receiving customer-provided image data comprises a computer connected to a global computer network.

3. The system of claim 1 wherein the system further comprises means for displaying the customer-provided image data for review by a postal authority whereby customer-provided image data is accepted.

4. The system of claim 1 wherein the means for receiving payment from a customer comprises a secure computer communications link whereby payment from a customer may be made electronically.

5. The system of claim 1 further comprising a customer accessible database of image data that a customer may utilize to compose an image for use on a postage stamp.

6. The system of claim 1 further comprising means for converting printed image data to electronic form.

7. The system of claim 6 wherein the means comprises a document scanner.

8. The system of claim 1 further comprising means for transmitting an electronic image of the postage stamps to the customer for review before the stamps are printed.

9. The system of claim 1 further comprising means for storing an electronic image of the postage stamp in a data base for retrieval by the customer.

10. A method of providing a customer with postage stamps including images provided by the customer including:
receiving image data from a customer in electronic form;
combining the image data with postal indicia to produce an electronic image of a postage stamp;
transmitting an image of a postage stamp including the image data received from the customer for customer review;
displaying the image data for review by a postal authority;
printing the postage stamp; and
forwarding the printed stamps to the customer.

11. The method of claim 10 further comprising receiving payment for the stamps.

12. The method of claim 10 further comprising billing the customer for the postage stamps.

13. The method of claim 10 further comprising providing the customer with access to a data base of image data whereby the customer may select image data from the data base for use on a postage stamp.

14. The method of claim 13 further comprising providing the customer with means for combining customer provided image data with image data from the data base to compose a combined image data for use on a postage stamp.

15. A method of providing a customer with postage stamps including images provided by the customer including:
receiving image data from a customer;
combining the image data with postal indicia to produce an electronic image of a postage stamp;
providing an image of a postage stamp including the image data received from the customer for customer review;
reviewing the image data for compliance with predetermined criteria;
printing the postage stamp; and
forwarding the printed stamps to the customer.

16. The method of claim 15 further comprising providing the customer with means for converting printed image data to electronic form.

17. The method of claim 16 wherein the means for converting printed image data to electronic form is located at one of a local postal office and a self-service center remote from postal offices.

18. The method of claim 15 further comprising providing the customer with a means for electronic payment.

19. The method of claim 15 further comprising providing the customer with means for remote display of an electronic image of the postage stamp prior to printing the stamps.

20. The method of claim 15 wherein the customer provided image data is received as one of printed images and image data recorded on magnetic media.
